(19) United States
(12) Patent Application Publication
(10) Pub. No.: US 2023/0088838 A1
(43) Pub. Date: Mar. 23, 2023

(54) LIGHT-BASED DATA COMMUNICATION SYSTEM AND METHOD FOR OFFLOADING DATA FROM A VEHICLE

(71) Applicant: Argo AI, LLC, Pittsburgh, PA (US)

(72) Inventors: Michel LAVERNE, Pittsburgh, PA (US); Dane BENNINGTON, Pittsburgh, PA (US)

(73) Assignee: Argo AI, LLC, Pittsburgh, PA (US)

(21) Appl. No.: 17/448,280

(22) Filed: Sep. 21, 2021

(51) Int. Cl. H04B 10/116; H04B 10/40; H04W 4/44; H04W 4/38

(52) U.S. Cl. CPC H04B 10/116; H04B 10/40; H04W 4/44; H04W 4/38

(57) ABSTRACT

A system and method for transmitting data using an autonomous vehicle's LIDAR system. The autonomous vehicle may transmit the data by disengaging the LIDAR system's transmitters and receivers from operating to detect external objects. The autonomous vehicle may also rotate the LIDAR system to locate one of a plurality of receivers external to the autonomous vehicle. Data stored within the autonomous vehicle may then be transmitted to an external system using a light-based communication path established between at least one of the LIDAR system's transmitters and an external receiver. The LIDAR system's transmitters and receivers may then be re-engaged so as to be operable to detect external objects.

### FIELD OF THE INVENTION

A light-based communication system and method for transmitting data/information stored within one or more autonomous vehicles using.

### BACKGROUND

LIDAR systems may be used for various purposes. When employed within an autonomous vehicle, LIDAR systems are typically used to detect objects and to provide range determinations. LIDAR systems within an autonomous vehicle may include one or more transmitters/emitter devices and more receivers/detectors may be housed in a rotating portion of the LIDAR system, such that light may be emitted and return light may be detected in various directions around the LIDAR system as the rotating portion of the LIDAR system rotates relative to the fixed portion. While operating in an autonomous driving mode, the LIDAR system may be operable to ascertain distance information for objects located within a full 360-degree field of view of the vehicle, rather than only in one direction that the one or more emitter devices and/or one or more detector devices are pointing.

### SUMMARY

A system and method is disclosed for transmitting (offloading) data from an autonomous vehicle using a LIDAR system. The system and method may disengage each transmitter within the LIDAR system and each receiver within the LIDAR system from being operable to detect objects external to the autonomous vehicle. One or more motors may rotate the LIDAR system to adjust a direction of at least one remote transmitter until at least one of a plurality of receivers external to the autonomous vehicle is located. It is contemplated the remote transmitter may operate using a wireless and/or light-based connection. Data stored within the autonomous vehicle is transmitted to an external system using a light-based communication path established between the at least one transmitter and the at least one of the plurality of receivers. Once the data has been transmitted to the external system, each transmitter within the LIDAR system and each receiver within the LIDAR system may be re-engaged to be operable to detect an object external to the autonomous vehicle.

It is contemplated the operation of the LIDAR system may be inhibited from operating to provide a scan pattern of an external environment. It is also contemplated the one or more motors of the LIDAR system may also be disengaged from spinning in a 360-degree direction when it is determined the autonomous vehicle is positioned in a location for transmitting data. A status information signal may also be transmitted from a remote system to the autonomous vehicle, wherein the status information signal is transmitted using a remote transmitter connected to the remote system. The status information signal may be used to indicate which one of the plurality of receivers will be used for transmitting the data from the autonomous vehicle to the remote system. The status information signal may also be used to indicate when the data has been successfully transmitted from the autonomous vehicle to the remote system. The status information signal may further be used to indicate whether a portion of the data has not been successfully transmitted from the autonomous vehicle to the remote system. Lastly, the status information signal is used to indicate that the LIDAR system should re-engage each transmitter within the LIDAR system and each receiver within the LIDAR system as being operable to detect the object external to the autonomous vehicle.

The method and system may also transmit data from the autonomous vehicle by disengaging a modulated active sensor from being operable to detect objects external to the autonomous vehicle. The modulated active sensor may include at least one transmitter and at least one receiver. A signal may be received from a remote system indicating a location where an external receiver is positioned. At least one of the modulated active sensors may be adjusted until the at least one transmitter is in communication with the external receiver. Data stored within the autonomous vehicle may be transmitted to an external system using a modulated communication path established between the at least one transmitter and the external receiver. A status information signal may be received indicating that the data stored within the autonomous vehicle has been transmitted. The modulated active sensor may then be re-engaged to detect an object external to the autonomous vehicle.

### BRIEF DESCRIPTION OF THE DRAWINGS

FIG. 1 illustrates an exemplary LIDAR system that may be coupled to a vehicle.

FIG. 2 illustrates a networking infrastructure for offloading data/information from an autonomous vehicle.

FIG. 3 illustrates an exemplary flow diagram for off-loading data/information using light-based data communication.

### DETAILED DESCRIPTION

Semi- and/or fully-autonomous vehicles may employ various sensors like cameras, sonar, or LIDAR. One or more vehicle controllers may store and process the data collected from these sensors to operate (i.e., drive) the vehicle. The vehicles employing such sensors may be part of large vehicle fleet operated by one or more organizations like an original equipment manufacturer (OEM), supplier, ride-sharing service, delivery service, or the like. The vehicle fleet may therefore be operably designed and deployed to provide autonomous or mapping functionality. The vehicle fleet may also be operably designed to return to a given depot location (e.g., storage or park location) at the end of a specified time-duration or when re-fueling is necessary.

For instance, a fleet of autonomous vehicles may be deployed to provide ride-sharing services for a period of 4-hours and then may be programmed to return to the depot location. While deployed, the fleet of vehicles would be operable to collect driving data/information as described above. The fleet of vehicles may also collect additional data/information about customers or passengers. The data collected may need to be offloaded from the vehicles to a data center or remote computing server for processing and/or storage.

The large amount of data collected by these vehicles multiplied by the size of the fleets can present difficulties in offloading the data. For instance, when a fleet of 100 vehicles return to a depot location the amount of data to be offloaded might be too large to handle using a wireless connection. For instance, the data may be offloaded using a cellular, WIFI, Bluetooth, or other wireless connections that may provide a wireless datalink. Issues with wirelessly transmitting the data within the confined depot location from numerous vehicles may include airtime fairness, interference, and congestion. Data charges for certain wireless connections (e.g., cellular) would also make such transmission of the data collected cost prohibitive. Additionally, it would be uneconomical to use a physically hard-wired connection (e.g., ethernet) to the entire fleet of vehicles due to the number of units that would need to be connected. Aside from it being uneconomical, hard-wired connections would also not be a viable option due to the wear and tear the connectors and wiring would endure from continually being connected/disconnected.

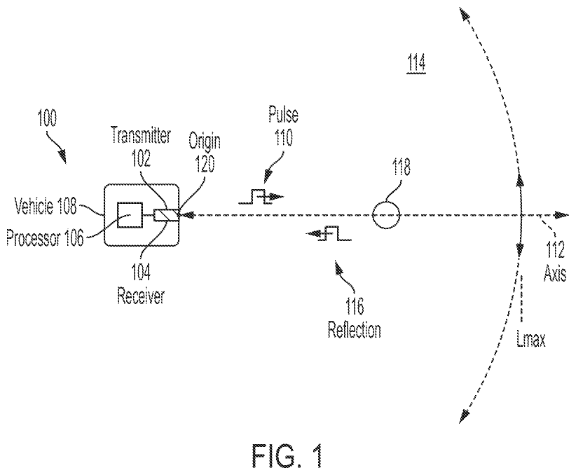

As such, there is a need for a system and method to offload stored data and information from a plurality of vehicles that may be located within a fixed location. As stated above, current autonomous vehicles include numerous sensors conventionally employed during normal operation for driving operations including a LIDAR sensor system typically operable for detection and 3-D mapping when driving on a given route. While FIG. 1 below generally describes an exemplary LIDAR system operating during detection/3-D mapping, the present disclosure also contemplates the same LIDAR system may also be operable to offload the data stored on the vehicle to a remote receiver. Using the LIDAR system to provide a light-based communication system would provide cost-savings by not requiring additional equipment to be added to the vehicle. The LIDAR system could also provide a communication connection with sufficient bandwidth to offload the data quickly and efficiently.

FIG. 1 depicts an exemplary LIDAR system 100 that may be employed by an autonomous vehicle. As illustrated LIDAR system 100 may include a transmitter 102, receiver 104, and processor 106. Transmitter 102 may be operable to transmit a train of pulses 110 along a detection axis 112. Or depending up on the application, transmitter 102 may alternatively be operable to transmit pulses 110 in varying horizontal (i.e., azimuth) or vertical directions different than the illustrated detection axis 112. Transmitter 102 may be an optical transmitter suitable for emitting a train of light pulses within a given wavelength (e.g., between the range of approximately 1350 nm to approximately 1390 nm).

It is also contemplated that transmitter 102 may generate the optical pulses using a laser source. For instance, the transmitter 102 may be a laser diode for emitting a light pulse. The receiver 104 (i.e., detector device) may be a photodetector, such as an Avalanche Photodiode (APD), or more specifically an APD that may operate in Geiger Mode, however, any other type of photodetector may be used as well. The APDs may be photodiodes that operate with a relatively large gain compared to normal photodiodes. The APDs may also be Geiger Mode APDs operated slightly above the breakdown threshold voltage, where even a single electron—hole pair can trigger an output signal that is identifiable by data processing elements.

The processor 106 may be used to perform any of the operations associated with the LIDAR system 100. While illustrated as a single processor 106, it is contemplated processor 106 may be comprised of multiple processors or may integrated as part of a larger processing unit (e.g., Engine Control Unit or “ECU”). The processor 106 may be designed using one or more commercially available processing unit that implements an instruction set such as one of the x86, ARM, Power, or MIPS instruction set families.

During operation, the processor 106 may execute stored program instructions that are retrieved from a memory unit. The stored program instructions may include software that controls operation of the processor 106 to perform the operation described herein. The memory unit may include volatile memory and non-volatile memory for storing instructions and data. The non-volatile memory may include solid-state memories, such as NAND flash memory, magnetic and optical storage media, or any other suitable data storage device that retains data when the LIDAR system 100 is deactivated or loses electrical power. The volatile memory may include static and dynamic random-access memory (RAM) that stores program instructions and data.

Transmitter 102 may also be operable to transmit given pulses 110 such that it has a given time duration (e.g., approximately 5 nanoseconds) at a particular repetition/frequency rate (e.g., approximately 300 kHz). But it should be understood the width of pulse 110 and the repetition rate of transmitter 102 may be a matter of design and pulse 110 can be modified to operate at different durations and repetition rates based the given application or operation.

It is also contemplated, LIDAR system 100 may be mounted to a vehicle. For instance, LIDAR system 100 may be mounted on the roof of a vehicle such that transmitter 102 and receiver 104 are substantially co-located. As such, the LIDAR system 100 may be operable to rotate or spin at a given frequency to allow light to be emitted in different directions up to a full 360-degree field of view around the LIDAR system 100. But it is also contemplated the LIDAR system 100 (including transmitter 102 and receiver 104) may be located in varying locations around the vehicle.

As previously discussed, LIDAR system 100 may be part of an autonomous vehicle that incorporates additional sensors. For instance, the vehicle may include a control system that collects and stores information or data from LIDAR system 100, one or more camera systems, one or more ultrasonic sensors, one or more radar sensors, and/or additional laser sensors. The control system may employ one or more algorithms on the stored data to provide semi/fully autonomous driving operations based on a vehicle position relative to a road and the position/velocity of surrounding objects (e.g., other vehicles, pedestrians and various obstacles).

Again, the data/information collected by LIDAR system (and additional sensors) may be stored in memory located within the vehicle. Additional data/information collected from passengers, customers, or other vehicle systems may also be stored within a vehicle memory unit. This data/information may include customer names, payment information, and the like. For fleet vehicles, this data/information may need to be uploaded each time a vehicle returns to a depot location. For instance, a vehicle that is part of a commercially deployed set of vehicles may be required to return to a depot location after a predefined duration (e.g., 8-hours) or when the vehicle needs to be refueled/recharged.

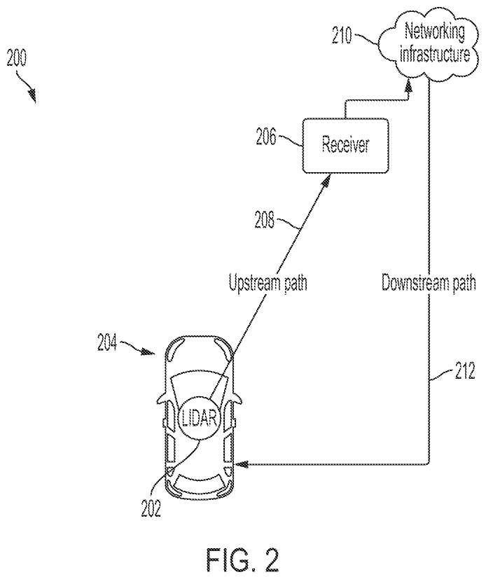

FIG. 2 illustrates an exemplary light-based communication system 200 that may be deployed at a depot location to offload data from a plurality of autonomous vehicles. As illustrated, a vehicle 202 with LIDAR system 204 (e.g., LIDAR system 100) may be situated at a depot location having one or more optical receivers 206. The optical receivers 206 may be situated at various locations around the depot location to allow simultaneous data offloading from a plurality of vehicles.

Each vehicle (e.g., vehicle 202) situated within the depot location may change the operational mode of the LIDAR system 204 to enter a homing sequence to detect, locate, or position itself for optical communication with a given receiver 206. A network infrastructure 210 that may include one or more computing systems may assign LIDAR system 204 to a given receiver based on the vehicle's location or the availability of a receiver. For instance, a given vehicle 202 may have stored the geo-graphical coordinates for each receiver 206 positioned within a given depot. The LIDAR system 204 may therefore be pre-assigned by infrastructure 210 to a given receiver 206 based on the vehicle's location within the depot. Or, because infrastructure 210 is in communication with all receivers located within the depot, it may determine that another vehicle is offloading data using receiver 206. As such, infrastructure 210 may alternatively assign vehicle 202 to a different receiver within the depot location.

Once assigned a given receiver (e.g., receiver 206), the LIDAR system 204 may adjust its azimuth and elevation so that a forward communication path 208 (light-based communication path) may be established. Infrastructure 210 may acknowledge communication 208 path has been established using downstream communication path 212. Infrastructure 210 may provide acknowledgement using one or more known handshaking or verification protocols. It is contemplated path 212 may also be used for latent or congested communication with the vehicle 202.

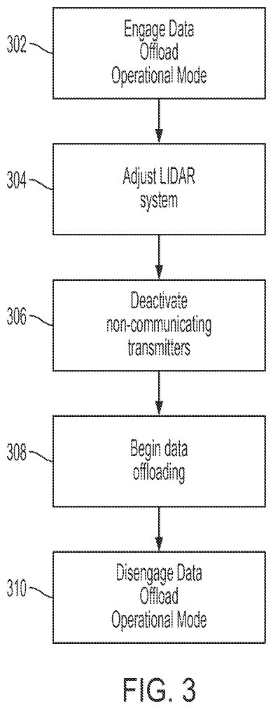

FIG. 3 is an exemplary flow diagram 300 illustrating operation of the LIDAR system 204 to provide light-based data offloading communication. At step 302, the LIDAR system 204 may be operable to engage a data offloading operational mode. Vehicle 202 may engage a data offloading operational mode upon being situated within a given position within the depot location. Or vehicle 202 may receive an external communication (e.g., wireless communication) to engage the data-offload operational mode. Once engaged, may begin a homing process to locate a given receiver. The homing process may first cease normal rotational operation. Once rotational operation is stopped, the power level of the LIDAR system 204 may also be adjusted to be compatible with the class of the unit.

At step 304, the azimuth and elevation of the LIDAR system 204 may be adjusted to locate the receiver 206. Again, the receiver 206 may be located at a fixed location already known by vehicle 202. If the vehicle 202 has the geographical location of receiver 206, the time necessary to adjust the LIDAR system 204 may be nominal. If the vehicle 202 does not have the geographical location of the receiver 206, the LIDAR system 204 may continue to be adjusted until receiver 206 is located.

LIDAR system 204 may send out a handshaking routine using path 208 and infrastructure 210 may provide an acknowledgement using path 212. As such, LIDAR system 204 will know when it has successfully located the receiver 206. It is also contemplated that a visual barcode or QR-code may be situated on or about receiver 206. The barcode may be used by LIDAR system 204 to identify it is adjusted and pointed toward the correct receiver. While it is contemplated that receiver 206 may be operable to receive data from more than one LIDAR system, it is also contemplated that numerous receivers may be positioned around depot location and each receiver may be in communication with a single LIDAR system.

Lastly, once LIDAR system 204 has located receiver 206 it may begin light-based communication across path 208. Again, infrastructure 210 may acknowledge the LIDAR system 204 is communicating with the correct receiver using the downstream/return path 212. Downstream path 212 may be established using a communication medium other than light-based communication (e.g., wireless). But it is also contemplated the return path may also be a light-based communication path where receiver 206 may operably be a transceiver capable of transmitting or receiving light-based communication. Or a separate transmitter may be located near receiver 206 for light based communication with LIDAR system 204.

At step 306, the LIDAR system 204 may deactivate all non-communicating transmitters. LIDAR system 204 may include numerous transmitters and receivers that would be used for obstacle detection and 3-D mapping. However, during light-based communication only a select number (e.g., one) transmitter may be required for data offloading. As such, all the remaining transmitters within the LIDAR system 204 may be deactivated to allow for improved thermal management, higher firing rate and a reduction in crosstalk issues.

At step 308, the LIDAR system 204 begins offloading or transmitting the data/information stored by vehicle 202. It is contemplated that due to the asymmetric nature of the connection and some of the limitations of the light-based forward path, the transport layer used may be different than the regular IP standard. Instead, it is contemplated that a delay-tolerant networking architecture (e.g., RFC4838) may therefore be implemented.

At step 310, the data-offload operational mode may be disengaged and the LIDAR system 204 may be set to a normal mode of operation. The infrastructure 210 may disengage the data-offload operational mode once a complete transmission of all the data/information is completed. It is contemplated, infrastructure 210 and vehicle 202 may be in communication across upload path 208 and return path 212 to ensure complete transmission of all the data and information. Known communication protocols may be employed to ensure that no data has not been received by infrastructure 210. For instance, LIDAR system 204 may transmit data packets of known sizes and quantities to infrastructure 210. If infrastructure 210 determines a given packet has not been received, infrastructure 210 may transmit a failure response along download path 212. Vehicle 202 may receive the failure response and proceed with a complete retransmission of all the data or a transmission of just certain packets or data that were not properly received by infrastructure 210. Once infrastructure 210 has confirmed a successful offloading of all the data, a success response may be transmitted along download path 212. Upon receiving the success response, vehicle 202 may disengage the data-offload operational mode and return the LIDAR system 204 to a normal mode of operation.

It is also contemplated the disclosed system and method may be performed using other forms of modulated active sensing technologies, such as sonar or radar. For instance, an autonomous vehicle having one or more sonar or radar sensors normally operable for detecting objects. The vehicle may again engage the data offload operational mode as discussed above with regards to Step 302. The vehicle may then adjust the sonar or radar sensors to locate the receiver 206, similar to step 306 discussed above. Once located, the sonar or radar sensors may begin offloading data as discussed above with regards to Step 308. Once the data has been downloaded the vehicle may disengage the data offload operational mode as discussed above with regards to Step 310.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable mediums having computer readable program code embodied thereon.

Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (erasable programmable read-only memory (EPROM) or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for transmitting data from an autonomous vehicle, comprising:
disengaging each transmitter within a LIDAR system and each receiver within the LIDAR system from being operable to detect objects external to the autonomous vehicle;
rotating one or more motors to adjust a direction of at least one transmitter until at least one of a plurality of receivers external to the autonomous vehicle is located;
transmitting data stored within the autonomous vehicle to an external system using a light-based communication path established between the at least one transmitter and the at least one of the plurality of receivers; and
re-engaging each transmitter within the LIDAR system and each receiver within the LIDAR system to be operable to detect an object external to the autonomous vehicle.

2. The method of claim 1, further comprising: stopping the LIDAR system from providing a scan pattern of an external environment when it is determined the autonomous vehicle is positioned in a location for transmitting data.

3. The method of claim 1, further comprising: transmitting a status information signal from a remote system to the autonomous vehicle, wherein the status information signal is transmitted using a remote transmitter connected to the remote system.

4. The method of claim 3, wherein the status information signal is used to indicate which one of the plurality of receivers will be used for transmitting the data from the autonomous vehicle to the remote system.

5. The method of claim 3, wherein the status information signal is used to indicate when the data has been successfully transmitted from the autonomous vehicle to the remote system.

6. The method of claim 3, wherein the status information signal is used to indicate whether a portion of the data has not been successfully transmitted from the autonomous vehicle to the remote system.

7. The method of claim 3, wherein the status information signal is used to indicate that the LIDAR system should re-engage each transmitter within the LIDAR system and each receiver within the LIDAR system as being operable to detect the object external to the autonomous vehicle.

8. The method of claim 3, wherein the remote transmitter operates using a wireless connection.

9. The method of claim 3, wherein the remote transmitter operates using a light-based connection.

10. A system for transmitting data from an autonomous vehicle, comprising:
a LIDAR system operable to disengage each transmitter within the LIDAR system and each receiver within the LIDAR system from being operable to detect objects external to the autonomous vehicle;
a controller operable to:
adjust one or more motors operable until at least one transmitter within the LIDAR system locates at least one of a plurality of receivers external to the autonomous vehicle;
transmit data stored within the autonomous vehicle to an external system using a light-based communication path established between the at least one transmitter and the at least one of the plurality of receivers; and
re-engage each transmitter within the LIDAR system and each receiver within the LIDAR system to be operable to detect an object external to the autonomous vehicle.

11. The system of claim 10, wherein the controller is further operable to: stop the LIDAR system from providing a scan pattern of an external environment when it is determined the autonomous vehicle is positioned in a location for transmitting data.

12. The system of claim 10, wherein the controller is further operable to: transmit a status information signal from a remote system to the autonomous vehicle, wherein the status information signal is transmitted using a remote transmitter connected to the remote system.

13. The system of claim 12, wherein the status information signal is used to indicate which one of the plurality of receivers will be used for transmitting the data from the autonomous vehicle to the remote system.

14. The system of claim 12, wherein the status information signal is used to indicate when the data has been successfully transmitted from the autonomous vehicle to the remote system.

15. The system of claim 12, wherein the status information signal is used to indicate whether a portion of the data has not been successfully transmitted from the autonomous vehicle to the remote system.

16. The system of claim 12, wherein the status information signal is used to indicate that the LIDAR system should re-engage each transmitter within the LIDAR system and each receiver within the LIDAR system as being operable to detect the object external to the autonomous vehicle.

17. The system of claim 12, wherein the remote transmitter operates using a wireless connection.

18. The system of claim 12, wherein the remote transmitter operates using a light-based connection.

19. A method for transmitting data from an autonomous vehicle, comprising:
disengaging a modulated active sensor from being operable to detect objects external to the autonomous vehicle, wherein the modulated active sensor includes at least one transmitter and at least one receiver;
receiving a signal from a remote system indicating a location where an external receiver is positioned;
adjusting at least one of the modulated active sensors until the at least one transmitter is in communication with the external receiver;
transmitting data stored within the autonomous vehicle to an external system using a modulated communication path established between the at least one transmitter and the external receiver;
receiving a status information signal that the data stored within the autonomous vehicle has been transmitted; and
re-engaging the modulated active sensor to detect an object external to the autonomous vehicle.

20. The method of claim 19, wherein the modulated active sensor includes a sonar sensor.
